(19) United States
(12) Patent Application Publication
(10) Pub. No.: US 2012/0155825 A1
(43) Pub. Date: Jun. 21, 2012

(54) CONTAMINATION PREVENTION MECHANISM FOR LIGHT PEAK STANDARD-A PLUG ASSEMBLY

(76) Inventor: Jamyuen Ko, Santa Clara, CA (US)

(21) Appl. No.: 12/971,848

(22) Filed: Dec. 17, 2010

(51) Int. Cl. G02B 6/00; H01R 43/00

(52) U.S. Cl. 385/139; 29/857

(57) ABSTRACT

A front cap assembly is provided for protecting a Light Peak (LPK) Standard A-plug assembly or similar optical plug from contamination, such as by dirt or liquid. In one embodiment a rotatable spring loaded cap may be provided to protect the optical plug when in an unplugged state. In another embodiment, a sliding spring loaded outer housing may be used.

### FIELD OF THE INVENTION

Embodiments of the present invention are directed to contamination prevention and, more particularly, to cap assemblies for preventing dust and moisture from contaminating USB-type plugs.

### BACKGROUND INFORMATION

In many of today's processing systems, such as personal computer (PC) systems, there exist universal serial bus (USB) ports for connecting various USB devices. Some of these USB devices are frequently used by PC users. For example, these USB devices may be printers, compact disk read-only-memory (CD-ROM) drives, CD-ROM Writer (CDRW) drives, digital versatile disk (DVD) drives, cameras, pointing devices (e.g., computer mouse), keyboards, joy-sticks, hard-drives, speakers, etc. Some of these devices use more of the available USB bandwidth than others. For example, a USB CDRW is a high bandwidth device, while human interface devices (HID), such as computer mice, keyboards and joysticks, are low bandwidth devices.

Within a USB cable there are typically four shielded wires. Two of the wires may provide power (+5 volts (red) and ground (brown)) and a twisted pair (blue and yellow) for data.

At either end of a USB cable there is a standard sized connector. These connectors each has a different profile designated “A” connectors and “B” connectors. More recently, mini versions of these connectors are appearing to accommodate smaller devices. “A” connectors head “upstream” toward the computer. On the other end, “B” connectors head “downstream” and connect to individual devices. This way, it is almost fool proof to make a wrong connection.

The USB standard allows for low power devices (e.g., mice, memory sticks, keyboards, etc.) to draw their power from their USB connection. Larger devices requiring more power, such as scanners or printers, typically have their own dedicated power supply.

FIG. 1 shows a typical USB “A” male connector 10. The cable 12, comprises the above mentioned four wires and connects to a plastic housing 14. Each of the four wires electrically connects within the housing 14 to one of four contact terminals or pins 16 mounted on the top side of an insulative base 18. The insulative base 18 is wrapped in a metal shield 19. Openings 20 in the metal shield may be provided to lock the connector in place when plugged into a corresponding female connector. Different standards of USB technology have different bandwidths. For instance, Universal Serial Bus Specification devices are capable of operating at 12 Mbits/second (Mbps). Universal Serial Bus Specification, revision 2.0 devices (USB2) are capable of operating at 480 Mbps. And, the more recent USB3 has seen speeds of 500 Mbps. However, as technology progresses engineers are constantly striving to increase operating speeds.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a plan view of a universal serial bus (USB) plug;

FIG. 2 is a plan view of an optical Light Peak (LPK) optical USB plug according to one embodiment;

FIG. 3 is an expanded view of an optical LPK optical UBS plug according to one embodiment;

FIG. 4 is a plan view of an optical LPK optical USB plug with a spring loaded protective cover in a closed position according to one embodiment;

FIG. 5 is a plan view of an optical LPK optical USB plug with a spring loaded protective cover in an open position according to one embodiment;

FIG. 6 is an expanded view of an optical LPK connector plug having a sliding protective cover according to another embodiment;

FIG. 7 a plan view of an optical LPK optical USB plug with a spring loaded sliding protective cover in a closed position according to one embodiment; and

FIG. 8 is a plan view of an optical LPK optical USB plug with a sliding spring loaded protective cover in an open position according to one embodiment.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

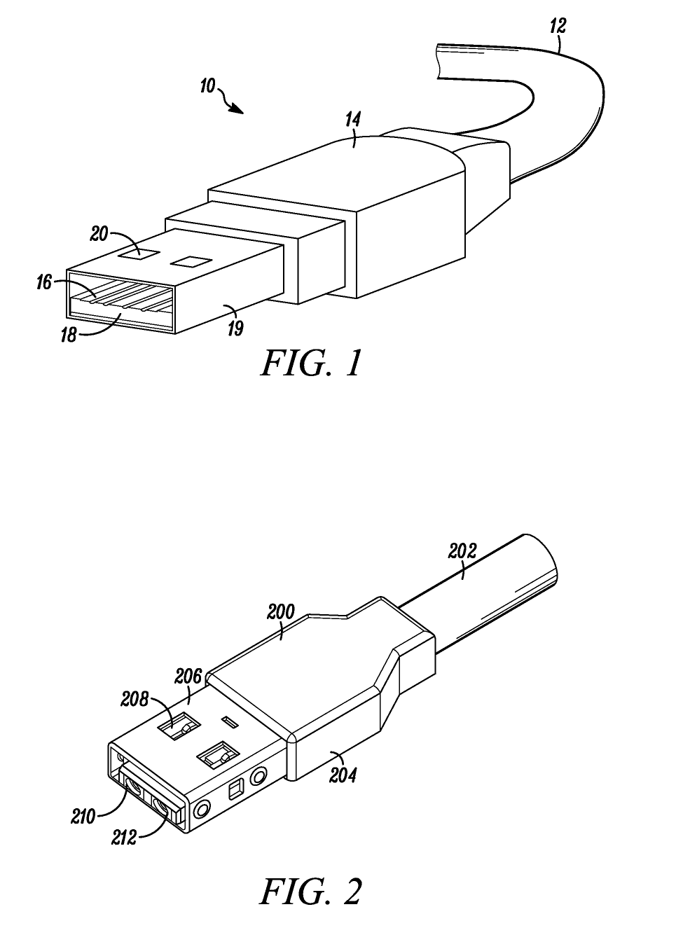

Referring now to FIG. 2 there is shown an example of a USB device with additional optical capabilities for achieving even greater bandwidths. The USB device 200 has been referred to as the so-called Light Peak (LPK) optical USB. As shown, a cable 202 may join with a plastic housing 204. A plug head 206 may include openings 208 in the head 206 used to lock the connector in place when plugged into a corresponding female connector. Optical ports 210 and 212 may be housed in the head 206 to provide optical capabilities. Electrical connections, such as 16 shown in FIG. 1 may also be included in some embodiments to provide backwards compatible capabilities with prior USB devices.

With optical devices, it may be desirable to prevent contamination, such as from liquid or dust from the optical components. It may also be desirable to prevent light from leaking out of the cable when it is in an unplugged state should the other end of the cable happen to be connected to a light source.

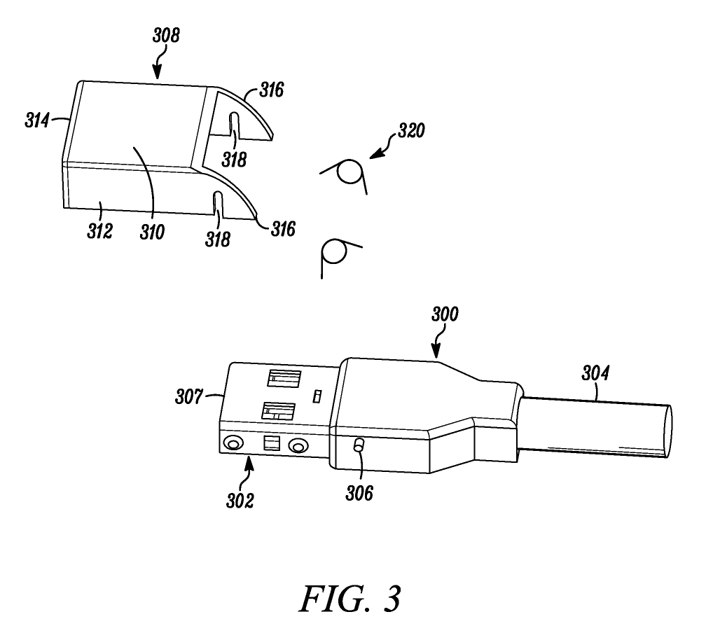

Referring now to FIG. 3, there is shown one embodiment of a front cap assembly for protecting the plug from contamination. In one embodiment, the invention may be directed to a Light Peak (LPK) Standard A-plug assembly, as shown in FIG. 2, but embodiments may also find use with any similar plug style. The plug may include an outer housing 300 securing a plug head 302 at one end and a cable 304 at the opposite end. The plug head may include an operation end 307 opening to optical and/or electrical components needing protection from contamination. Hinge cams 306 may protrude from both sides the outer housing 300 nearer the plug head 302. The hinge cams 306 may be generally cylindrical in shape. One hinge cam 306 is shown, but there is a second hinge cam one the opposite side of the outer housing 300 which is out of view.

A front cap 308 may be provided which has a top lid 310, lateral sides 312 and a front cover 314. The front cap 308 may be made, for example from plastic or other suitable material. Hinge brackets 316 may be included on the back end of the lateral sides 312 opposite the front cover 314. Slats 318 may be formed in the hinge brackets 316 to engage the hinge cams 306 on the outer housing 300. Torsion springs 320 or other biasing means may be provided to keep the front cap 308 biased in a normally closed position when the front cap is assembled with the outer housing 300.

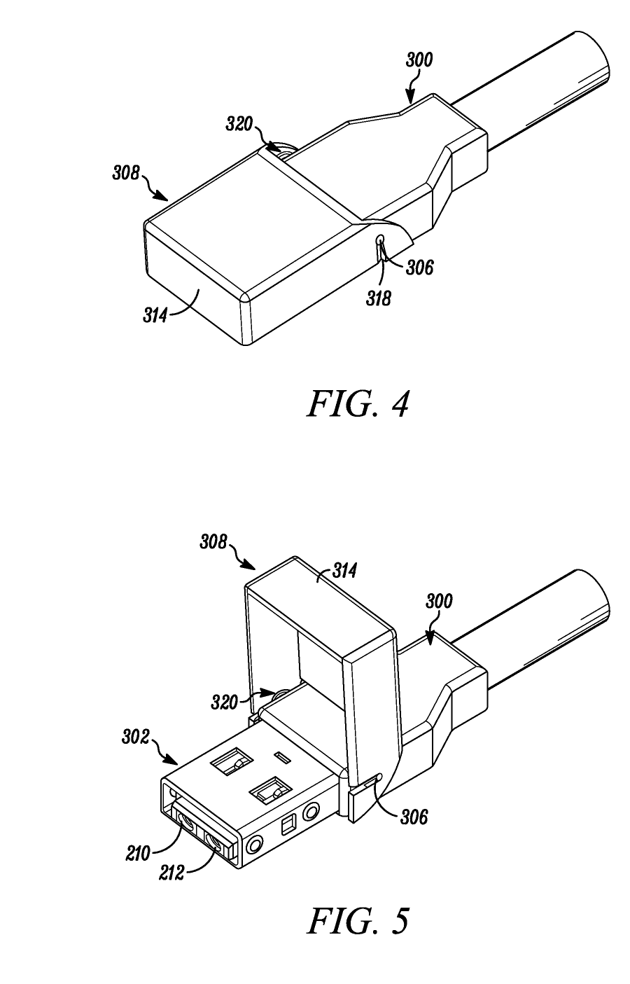

As shown in FIG. 4, the front cap 308 is assembled to the outer housing 300 with the slats 318 of the front cap 308 fitted with the cams 306 of the outer housing 300. Since the plug is not plugging in to a mating connector the torsion springs 320 tend to keep the front cap 308 biased down in a closed position with the front cover 314 covering the optical components of the plug.

FIG. 5 shows the plug of FIG. 4 with the front cap 308 in an open position such that it may be plugged into a mating connector. The front cap 308 is hinge-joined to the outer housing 300 and it can freely rotate about the cam 306. In nominal position (FIG. 4), the front cap 308 covers the entire plug head including optics 210 and 212 thus preventing contamination from entering and light from exiting. In operation, a user may apply force to rotate the front cap to expose the plug head 302 for connector engagement as shown in FIG. 5. To disengage the plug assembly, a user pulls the outer housing 300. Since the front cap 308 is spring loaded by biasing springs 320, it will automatically rotate back to the nominal position to cover the plug head 302.

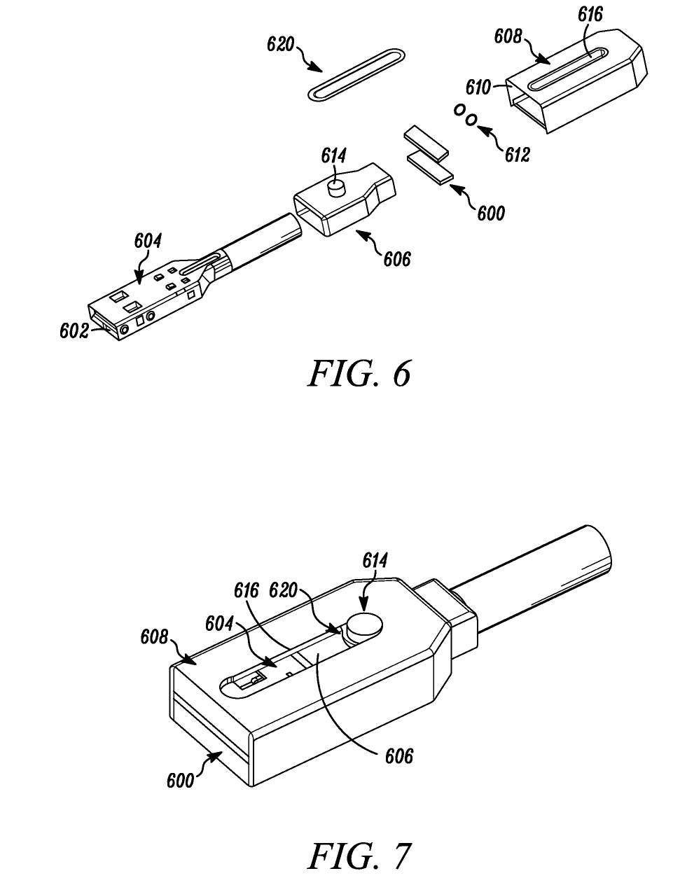

FIG. 6 shows yet another embodiment of the present invention which may comprise a sliding mechanism with double front doors 600 to protect the operational portion 602 of the plug head 604. As shown, an inner housing 606, which may be comprised of plastic, fits over the plug head 604. In this case, the inner housing 606 may be comparable to the outer housing 300, shown for example, in FIG. 4 of the previous embodiment. An outer housing 608 is made to fit over the inner housing 606 and the plug head 604. A pair of front doors 600 may be hinged at a front opening 610 of the outer housing 608. The pair of front doors 600 may be spring biased by torsion springs 612 to normally be in a closed position. The inner housing 606 may include a hub 614 on its top side. The hub 614 may be generally cylindrical in shape and fashioned to freely slide within a channel opening 616 running substantially the length of a top side of the outer housing 608. An elastic band 620, such as a rubber band or other suitable biasing means may be provide to fit over the hub 614 to bias it against the outer housing 616.

Referring now to FIG. 7, there is shown the embodiment of FIG. 6 in an assembled state. As shown, the outer housing encases the inner housing 606 and the plug head 604. The hub 614 is slidably positioned within the channel opening 616 in the outer housing 608 with the elastic band 620 pulling the hub 614, and thus the plug head 604, inside of the outer housing 608 with the torsion springs 612 holding the pair of doors 600 in a closed position to protect the operational portion 602 of the plug head 604.

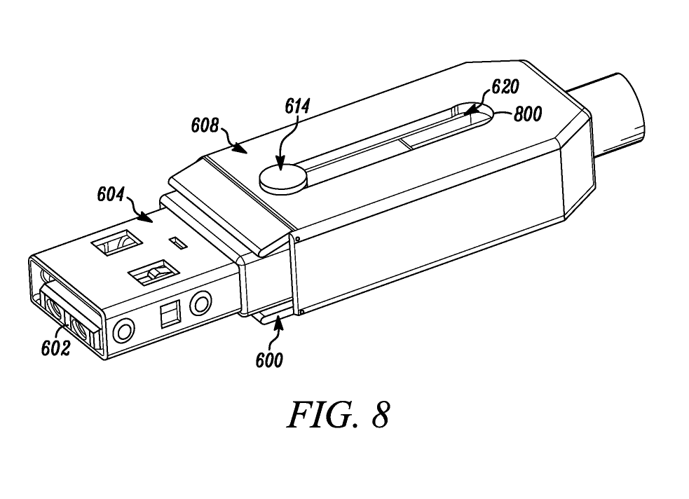

As shown in FIG. 8, the plug head is in an open position with the operational components 602 exposed and ready to be plugged into a mating connector. In nominal position, both front doors overlap each other covering the plug head 604, as shown in FIG. 7. In operation, a user pushes the hub at the inner housing to move outer housing 608 backward. The plug head will expose for connector engagement as the outer housing keeps moving backward until it is stopped at the keyed end. The rubber band 620 is stretched and is trying to drag the outer housing to the nominal position but the slot at the outer housing has keyed ends 800 to lock the hub 614.

To disengage the plug assembly, a user pulls the outer housing backward. After disengagement, the user may apply a small force to the outer housing 608 to overcome the lock key 800 so that the rubber band 620 will drag it to nominal position (see FIG. 7).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
an optical plug including an outer housing for securing a plug head to a cable;
optical components exposed at a terminal end of the plug head;
a cap having a top lid, lateral sides, and a front cover; and
a hinge for hinging the cap to the outer housing.

2. The apparatus as recited in claim 1 further comprising:
biasing means for biasing the cap in a normally closed position with the front cover over the optical components.

3. The apparatus as recited in claim 2 wherein the biasing means comprises a pair of torsion springs.

4. The apparatus as recited in claim 1 wherein the hinge comprises slats in the lateral sides of the cap to pair with hubs protruding from the outer housing.

5. A method, comprising:
providing an optical plug including an outer housing for securing a plug head to a cable;
providing optical components exposed at a terminal end of the plug head;
providing a cap having a top lid, lateral sides, and a front cover; and
rotating the cap between a closed position with the front cover covering the optical components and an open position with the optical components exposed.

6. A method as recited in claim 5 further comprising:
biasing the cap in a normally closed position with the front cover over the optical components.

7. The method as recited in claim 6 wherein the biasing is accomplished by torsion spring.

8. The method as recited in claim 5, further comprising:
providing a hinge comprising slats in the lateral sides of the cap to pair with hubs protruding from the outer housing for rotating the cap.

9. An apparatus, comprising:
an optical plug including an inner plug housing for securing a plug head to a cable;
optical components exposed at a terminal end of the plug head;
an outer housing for housing the optical plug;
a hinged door at a terminal end of the outer housing for covering the optical components,
wherein the optical plug can slide into and out of the outer housing.

10. The apparatus as recited in claim 9, further comprising:
a hub on a top side of the inner housing protruding to a slot on a top side of the outer housing to apply a force to slide the optical plug into and out of the outer housing.

11. The apparatus as recited in claim 10 further comprising:
a first biasing means for biasing the optical plug inside the outer housing in a normally closed position,

12. The apparatus as recited in claim 11, wherein the first biasing means is an elastic band.

13. The apparatus as recited in claim 10 further comprising:
a second biasing means for biasing the hinged door in a normally closed position.

14. The apparatus as recited in claim 13 wherein the second biasing means comprises a torsion spring.

15. The apparatus as recited in claim 9 wherein the hinged door comprises a pair of doors.

16. The apparatus as recited in claim 10 further comprising:
keyed portions at one or both ends of the slot in the outer housing for locking the hub in an open or closed position.
